(19) United States
(12) Patent Application Publication
(10) Pub. No.: US 2007/0033136 A1
(43) Pub. Date: Feb. 8, 2007

(54) Secured financial transaction device

(76) Inventor: Yih-Chun Hu, Urbana, IL (US)

Correspondence Address: LEE & HAYES PLLC, 421 W RIVERSIDE AVENUE SUITE 500, SPOKANE, WA, 99201, US

(21) Appl. No.: 11/198,209

(22) Filed: Aug. 5, 2005

(51) Int. Cl. G06Q 40/00

(52) U.S. Cl. 705/39; 705/35; 705/40

(57) ABSTRACT

An electronic device provides a trusted computing platform for authenticating online financial transactions. In one implementation, financial terms are enciphered by a financial entity using a key that is unknown to the user's computer and transmitted over a network to the user's computer. The device receives the enciphered terms from the user's computer and deciphers the terms. The device is equipped with a display to present the deciphered terms and one or more input mechanisms to allow the user to approve or cancel the transaction based on the terms presented on the device's display. The device enciphers the user's reply and returns it to the financial entity via the user's computer.

### TECHNICAL FIELD

This disclosure relates to electronic financial transactions and devices for making financial transactions secure.

### BACKGROUND

Financial transactions are increasingly being conducted online. Many banks allow its customers to bank online over the Internet. Online banking significantly reduces the costs per transactions, making banks more efficient and/or more profitable. In addition to banking, other financial transactions are also being handled online. Brokerage institutions permit members to trade online and electronically access their brokerage accounts. Merchants and other service providers (e.g., utilities, telephone companies, etc.) allow customers to access accounts electronically and pay bills online, either directly or via a payment service such as PayPal®, PayDirect from HSBC, and MoneyZap® services. Online gambling is also growing, facilitating payment and receipt of funds for accounts supporting such activity.

Most users access these online financial services using conventional home computers, such as desktop PCs (personal computers). With the rise of viruses, there is substantial risk that these computers are, or may become, infected with unwanted malicious programs, such as spyware, worms, spam, illegal file sharing, and so forth. As a result, the user's main point of access to sensitive financial information is often a compromised computer. Unfortunately, it is difficult for users to fight against such malicious programs. First, the user is often unaware that a malicious program exists. Second, installing protective software to prevent execution of such programs can be challenging for the normal computer user. And, third, the user often compounds the problem by naively installing random programs that have not been verified as being free from viruses or malicious code. Thus, it is becoming increasingly difficult to solve this problem through solutions related to the current desktop computer.

Accordingly, there is a need to improve the way online financial transactions are conducted.

### SUMMARY

An electronic device provides a trusted computing platform for authenticating online financial transactions. In one implementation, the device is a peripheral unit to the user's desktop computer. Financial terms are enciphered by a financial entity using a key that is unknown to the user's computer and transmitted over a network to the user's computer (e.g., using public key cryptography). The device receives the enciphered terms from the user's computer and deciphers the terms. The enciphered terms may be passed from the user's computer to the device via a USB connection (or other type of connection) or read optically by the device when displayed on the user's computer. The device is equipped with a display to present the deciphered terms and one or more input mechanisms to allow the user to approve or cancel the transaction based on the terms presented on the device's display. The device enciphers the user's reply and returns it to the financial entity via the user's computer.

### BRIEF DESCRIPTION OF THE CONTENTS

The detailed description is described with reference to the accompanying figures. In the figures, the left-most digit(s) of a reference number identifies the figure in which the reference number first appears. The use of the same reference numbers in different figures indicates similar or identical items.

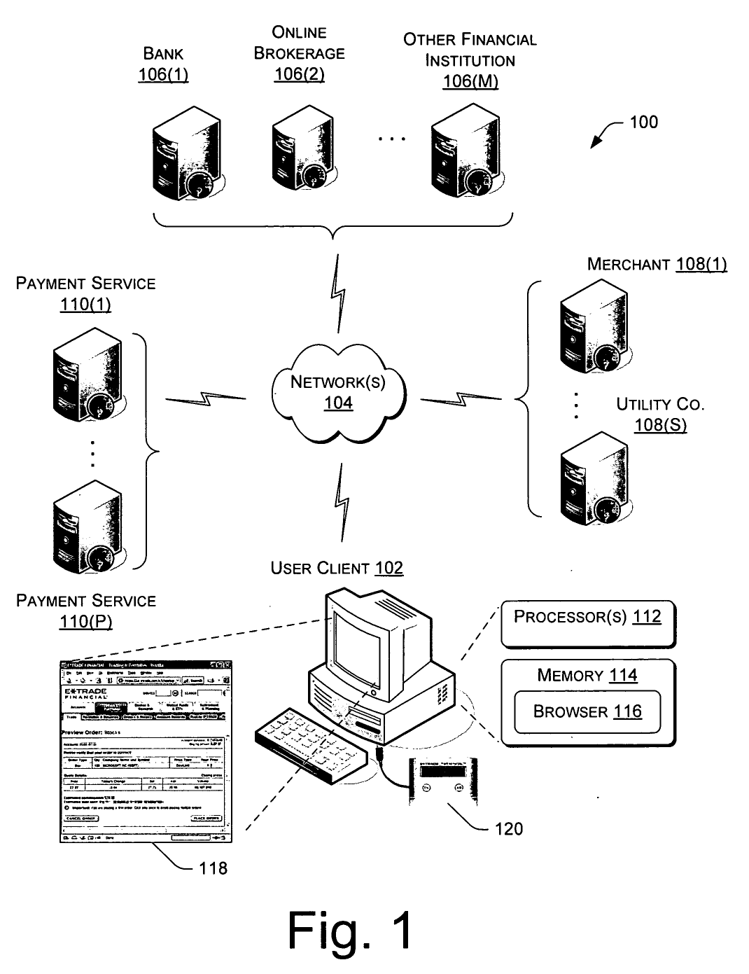

FIG. 1 illustrates an exemplary architecture for online financial transactions.

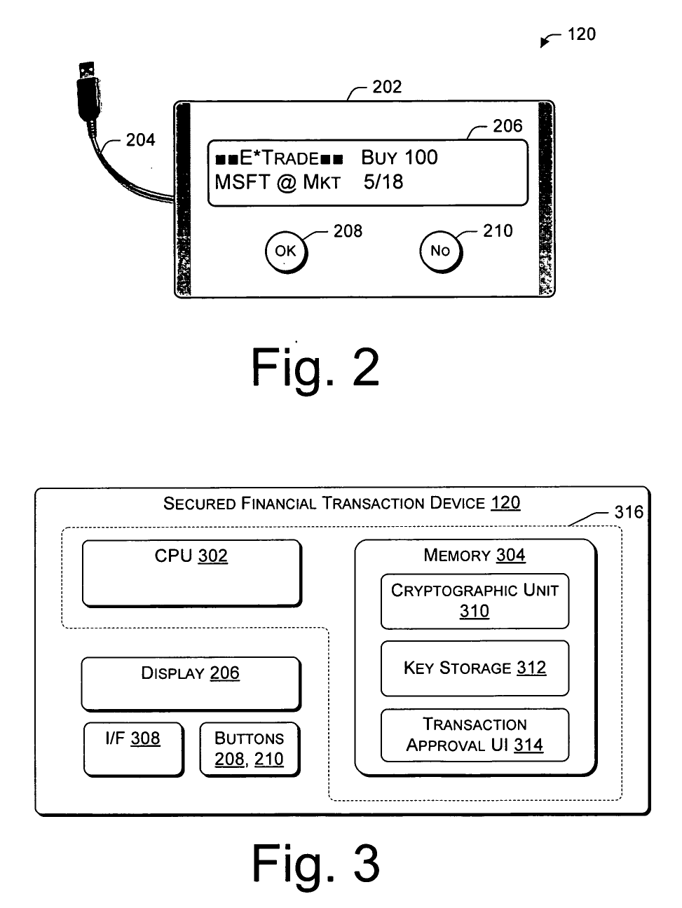

FIG. 2 shows a diagrammatic illustration of one example of an electronic peripheral device that facilitates secure online financial transaction.

FIG. 3 shows selected components of the electronic peripheral device of FIG. 2.

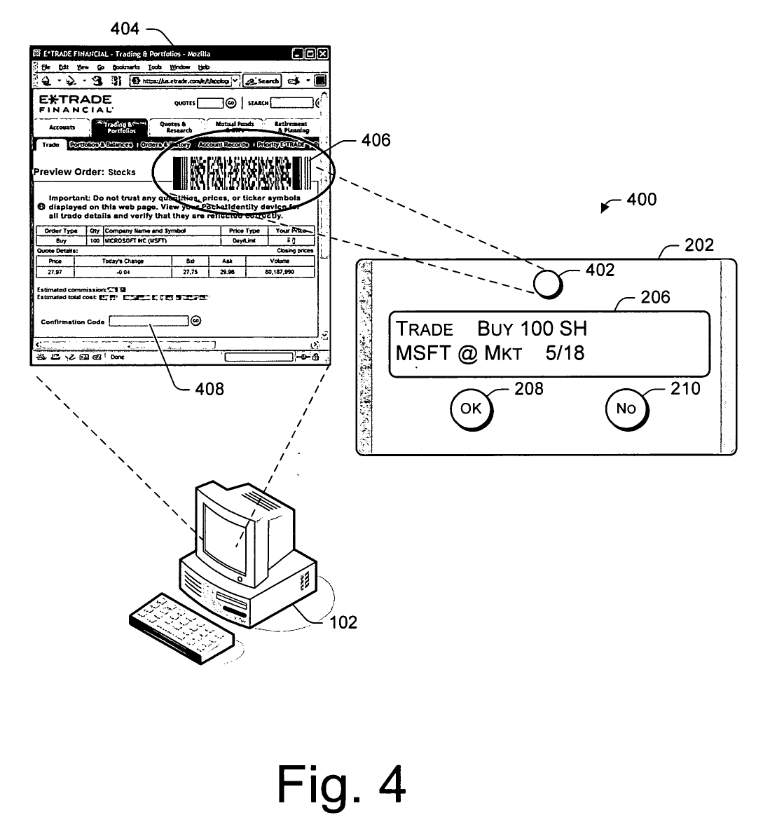

FIG. 4 shows a diagrammatic illustration of a second example of an electronic peripheral device that facilitates secure online financial transaction.

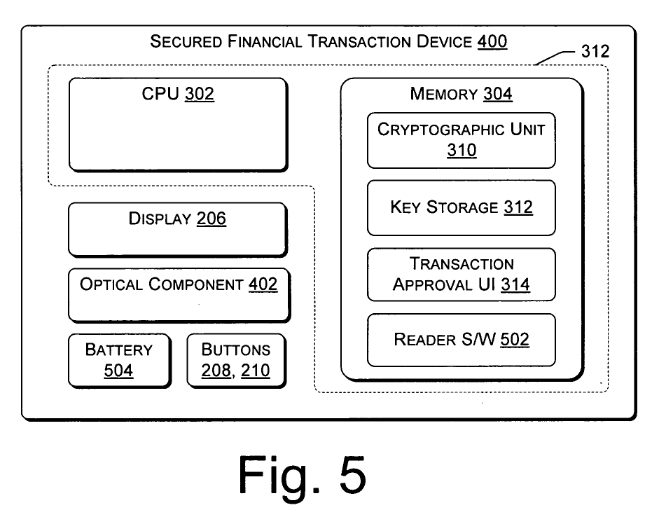

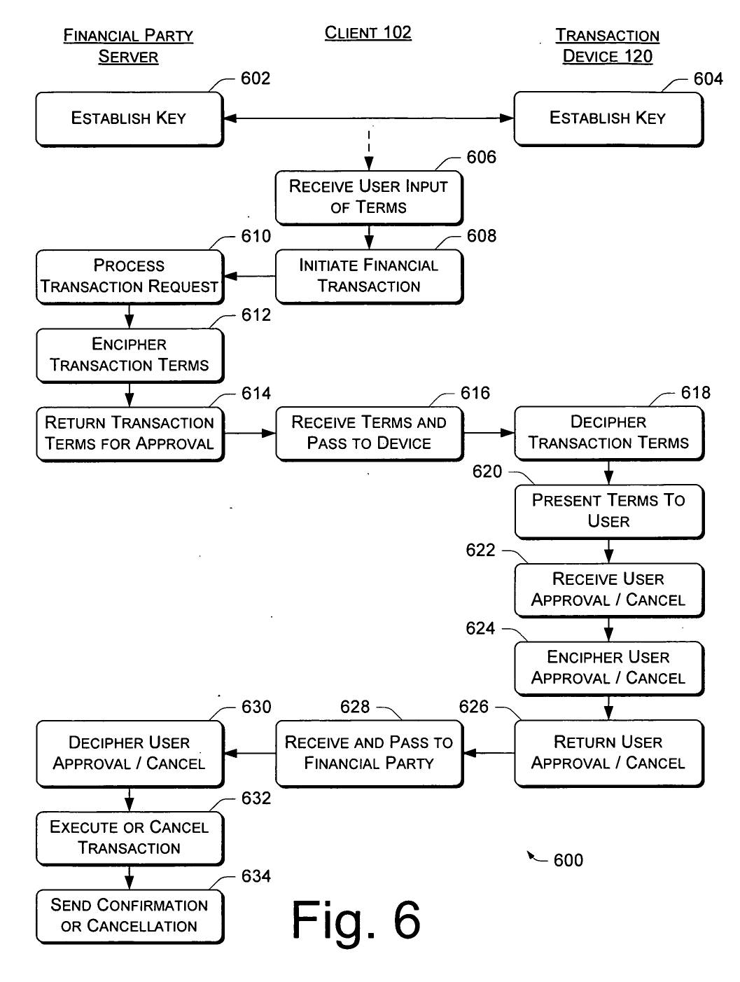

FIG. 5 shows selected components of the electronic peripheral device of FIG. 4.

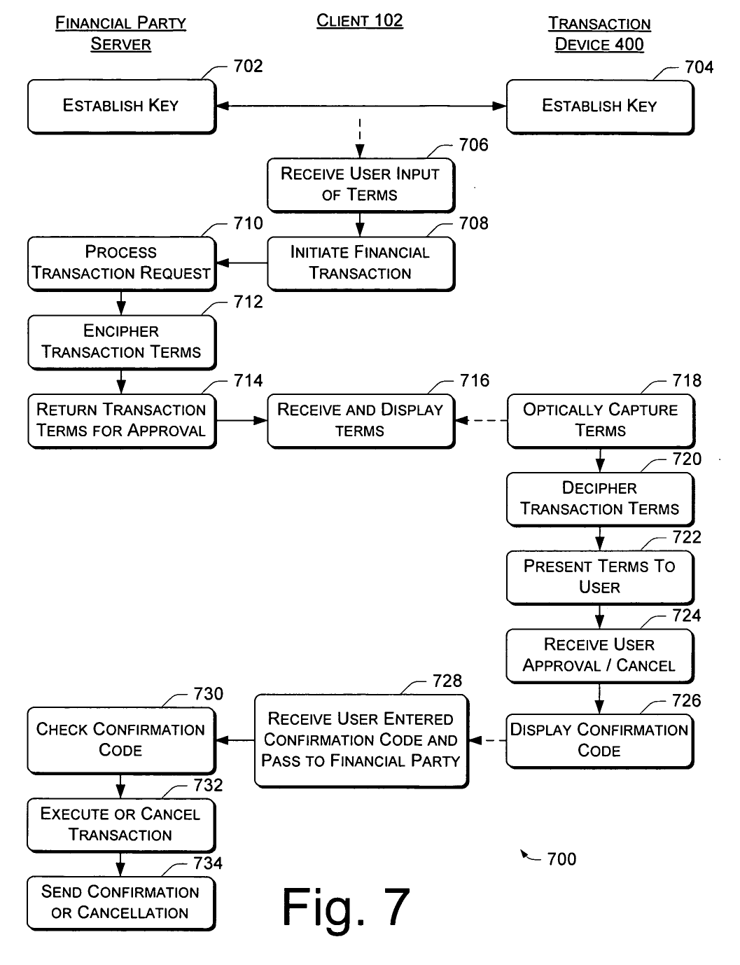

FIG. 6 is a flow diagram of a process for conducting secure online financial transactions.

FIG. 7 is a flow diagram of another process for conducting secure online financial transactions, where the process employs an electronic device equipped with optical recognition capabilities such as those found in the device of FIGS. 4 and 5.

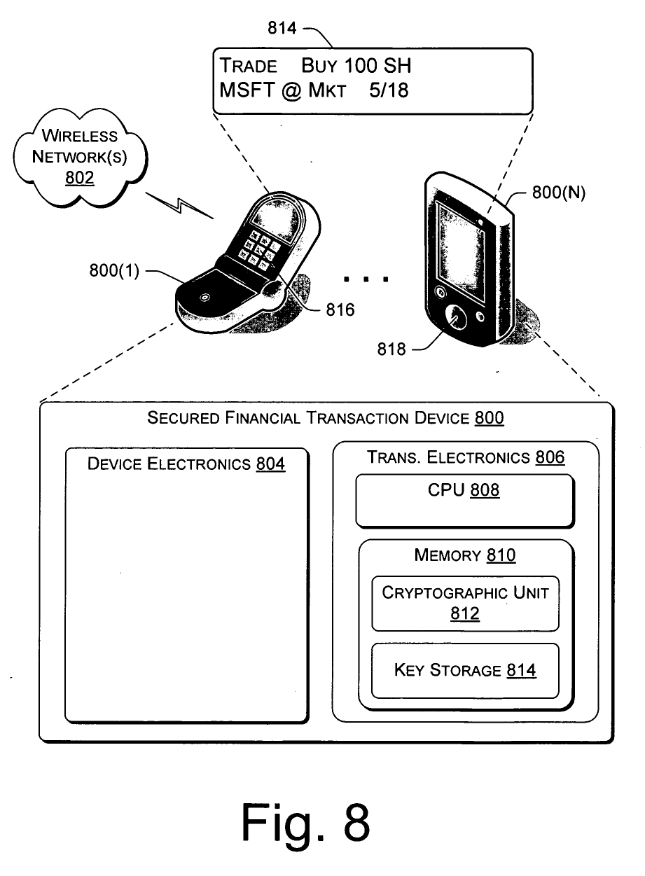

FIG. 8 illustrates example embodiments of multi-function devices that are configured to facilitate secure online financial transaction.

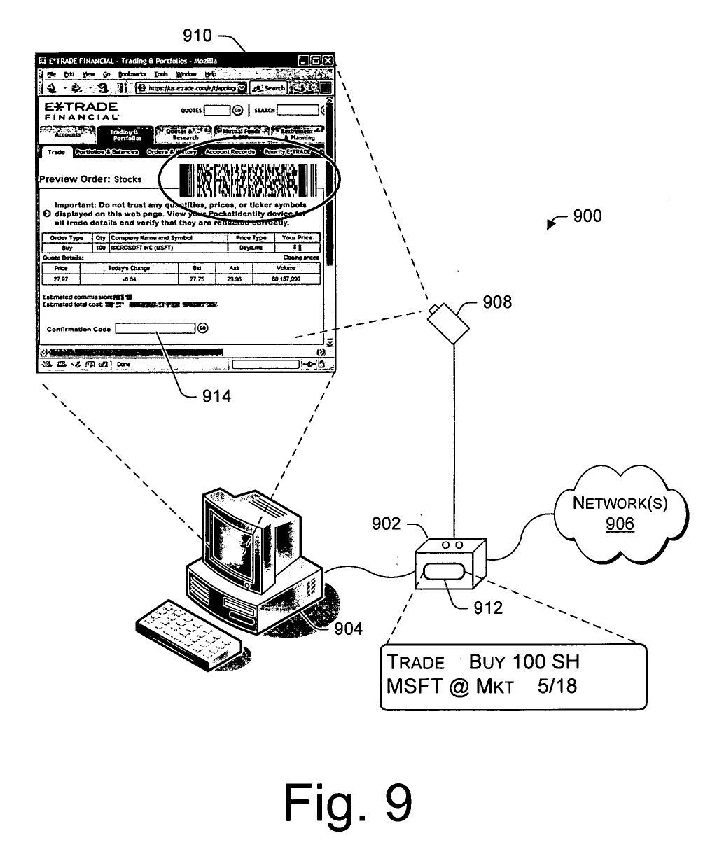

FIG. 9 illustrates another implementation of a system for facilitating secure online financial transaction.

### DETAILED DESCRIPTION

This disclosure is directed to techniques for securing online financial transactions. As disclosed herein, an electronic device provides a trusted computing platform for authenticating online financial transactions. The device is peripheral to the user's computer and receives the terms of a financial transaction from the other party via the user's computer. The device deciphers and authenticates the terms of the financial transaction and then allows the user to confirm or cancel the transaction prior to its completion. The peripheral device employs tamper resistant technologies to prevent rogue attempts to compromise the device. Additionally, by being separate from and peripheral to the user's computer, the device treats the computer as part of the unsecured network between it and the other party to the transaction. Thus, even if the user's computer is compromised, the user can still trust the accuracy of the transaction.

System Architecture

FIG. 1 illustrates an architecture 100 that represents an exemplary environment for online financial transactions. Architecture 100 includes a user client 102 that can connect to a network 104 to access one or more other parties that might be involved in a financial transaction. Client 102 is illustrated as a personal computer, but may be implemented as other computing devices, such as a laptop computer, a set-top box, a portable digital assistant (PDA), a cell phone, and so forth. The network 104 is representative of any one of many different types of networks, such as cable networks, the Internet, and wireless networks.

The client 102 conducts online financial transactions with any number and type of parties, including other people, business entities (companies, corporations, partnerships, etc.), non-profit organizations, and so forth. In this example, the client may participate in online financial transactions with various financial institution sites, represented by servers 106(1), 106(2), . . . , 106(M). Examples of such financial institutions include bank sites 106(1) and brokerage sites 106(2). By accessing an online bank site 106(1), the user can view bank account balances, withdraw or deposit funds, transfer money between accounts, make mortgage payments, and so forth. By accessing a brokerage site 106(M), the user is able to review account information, place or cancel trades, withdraw money, conduct research, and so forth.

The client 102 may also access accounts and pay bills via online sites 108(1), . . . , 108(S) associated with goods and services providers, as represented by an online merchant 108(1) and a utility company 108(S). The client 102 may further use one or more payment service sites 110(1), . . . , 110(P) to pay bills and manage accounts online. It should be appreciated that parties other than those shown in FIG. 1 may be involved in online financial transactions with the client 102.

Each financial party's website is accessible over the network 104 and hosted by servers that are capable of handling requests from clients. The site servers 106, 108, and 110 facilitate online financial transactions between the user and the party. The host servers generate and serve pages that are rendered at the client 102 to present the terms of the financial transaction.

Client 102 is equipped with one or more processors 112 and memory 114 to store applications and data. A browser application 116 is shown stored in memory 114 and executes on a processor 112 to provide access to the websites 106, 108, and 110 hosted by online financial parties and to render web pages served by the servers.

To engage in a financial transaction, the user employs the client 102 to interact with another party over the network 104. The user accesses the party's website and may log in using an account name and password. This creates a session during which the transaction can be negotiated and completed. Communication between the parties can be protected via a secure channel (e.g., SSL) over the network 104. The financial party's server generates and serves the pages for the transaction, and the user enters the appropriate information. Consider, for example, a financial transaction involving the placement of an equity trade on a brokerage site. The brokerage server provides a page that, when rendered, allows the user to fill in the equity name, the number of shares, the type of trade, and any conditions. In response, the brokerage server generates and returns a trader order page listing the information entered by the user. One exemplary page 118 is illustrated in FIG. 1 for the broker institution “E*Trade Financial Corporation”.

The user assumes that if the information in page 118 matches what she submitted, the terms are correct and she can confirm the trade. However, if the user's computer 102 is somehow compromised, the information may be altered prior to execution of the trade by the brokerage without the user's knowledge and to the user's detriment. Furthermore, if a rogue operator obtained confidential information surrounding the user's account (e.g., account numbers, passwords, balances, etc.), that operator could place trades without the user's knowledge.

To prevent such scenarios, the user system is also equipped with a financial transaction device 120 that provides a trusted computing platform for authenticating online financial transactions. The device is a small electronic device that is non-programmable. It can be configured with tamper-resistant technologies, such as smart card circuitry designs. The device 120 is configured as a peripheral to the user's client 102, being coupled thereto via a cable or bus, such as a USB (Uniform Serial Bus) connector. In this implementation, the client 102 communicates to the device 120 by acting like a serial port, parallel port, network port, or other communications port. The device 120 communicates back to the client 102 by acting like a user input device (e.g., keyboard), a serial port, a parallel port, a network port, other communications port. In another implementation, the device 120 may further be equipped with an optical bar code reader to read bar coded messages on the page provided by the financial institution. This implementation is described below with reference to FIGS. 4 and 5.

During an online financial transaction, the terms are passed from the other party's servers over the network 104 to the user's client 102, and then to the peripheral device 120 via the USB connector. The device 120 has a cryptographic engine to ensure secure communication with the other financial party's servers over an otherwise open and unsecured network 104 and a potentially compromised client 102. After deciphering the terms, the device 120 presents the terms of the financial transaction on a display for user verification. For instance, the device might show the type of trade, ticker symbol, number of shares, and price. The device also has one or more user input mechanisms (e.g., buttons) for the user to confirm or cancel the transaction based on the terms being presented on the display. The confirmation/cancellation is then securely communicated back to the party's servers via the connector, user client 102, and network 104. In this manner, the trusted peripheral device 120 treats the user's client 102 as part of the malicious network between the user and the other party.

To more particularly illustrate the architecture dataflow, consider the following example transactions involving the purchase of 100 shares in Microsoft Corporation (ticker symbol “MSFT”). In a first scenario, the client 102 is not compromised. The user accesses a brokerage institution and enters an order via the client 102 to buy 100 shares of MSFT at market. The computer conveys this order to the institution, which in response, generates and returns a reply with the trading terms. The reply is encrypted and securely passed from the institution through the client 102 to the transaction device 120, where the terms are decrypted and displayed. Since the terms are accurately displayed, the user approves the transaction using device 120 and the confirmation is encrypted and securely passed back to the institution. Upon receiving confirmation, the brokerage executes the trade.

Now, suppose that client 102 is compromised and maliciously altered the order entered by the user (without the user's knowledge) so that the purchase order, as sent to the brokerage institution, is for 1,000 shares of Microsoft Corporation, rather than the 100 shares entered on the client browser. The institution generates and returns a reply with the trading terms of 1,000 shares. The reply is securely passed through the compromised client 102 to the transaction device 120, where the device displays the terms to buy 1,000 shares of MSFT. Since the terms are inaccurate, the user cancels the transaction by pressing a cancel button on the device 120 and the cancellation is securely passed back to the institution. Upon receiving cancellation, the brokerage foregoes execution of the trade.

Device Architectures

FIG. 2 shows one exemplary implementation of the peripheral device 120. It has an encasing 202 that houses the secure and tamper-resistant circuitry and a connector 204 that couples the device 120 with the user's client. In this implementation, the connector 204 is a USB (Uniform Serial Bus) connector, although other wired connection interfaces may be employed. Furthermore, the device 120 may alternatively employ wireless interfaces (e.g., Bluetooth) to communicate with the user's client.

The peripheral device 120 has a display 206 to depict the transaction terms to be confirmed or canceled by the user. In one implementation, the display 206 is embodied as an M row by N character display. As one example, the display has 2 rows (M=2), each with 16 characters (N=16). The peripheral device 120 further includes one or more user input mechanisms, such as actuatable buttons, a touch screen incorporated into display 206, a touch pad, a thumbstick, a roller mechanism, and the like. In FIG. 2, the user input mechanism is implemented as two actuatable buttons, including a confirmation button 208 (labeled, for example, as “OK”) and a cancellation button 210 (labeled, for example, as “No”).

When a transaction is received by the device 120, the terms are deciphered and presented on the display 206. In the illustrated example of FIG. 2, the display 120 shows the terms of a brokerage transaction with a broker “E*Trade” involving the purchase of equity in Microsoft Corporation. Accordingly, the terms shown on display 206 include the broker name “E*Trade”, the transaction to purchase 100 shares (i.e., “buy 100”) of Microsoft Corporation (i.e., “MSFT”) at the market price (i.e. “@ Mkt”) on May 18^{th}. It should be noted that other information may be presented, and the information may be organized in a different format or arrangement.

Certain characters depicted on the display 206 are secure characters which are, by definition, not part of the transaction. In this example, the secure characters are square demarcations surrounding the broker's name “E*Trade”, although other types of demarcations may be used. The square demarcations are never part of the financial terms, but are intended to aid the user in reviewing the terms. In this case, the device is configured to support financial institutions with many different parties (rather than one dedicated party) and hence the transaction party's name “E*Trade” set apart from other text by square demarcations to inform the user that this transaction involves the party “E*Trade”. If the device is dedicated to only one financial partner (e.g., exclusive to E*Trade Financial Corporation), the name of the financial entity need not be included, nor the secure characters.

FIG. 3 shows selected functional components of the transaction device 120. The device has a central processing unit (CPU) 302, memory 304 (e.g., volatile and non-volatile), display 206, an interface 308, and one or more buttons 208, 210. The interface 308 supports communication with the client 102 over the cable 204. One example interface is a USB interface. Another example is a wireless interface (e.g., Bluetooth).

The memory 304 stores one or more programs that may be executed on the CPU 302. A cryptographic unit 310 is shown stored in memory 304. The cryptographic unit 310 performs various cryptography functions, including, for example, asymmetric key encryption (e.g., RSA), symmetric key encryption (e.g., DES), pseudorandom number generation, digest generation and hashing, digital signing and authentication, and key management. During manufacturing, the device is assigned a unique pair of public and private keys that are used by the cryptography unit 310. The keys are stored in a key storage 312. The keys are used by the device to encrypt and decrypt messages exchanged with the other party to the financial transaction. The device may further store one or more certificates in the key storage. The certificates contain information about the device, such as a device ID, and also the device's public key. The certificate can be exchanged with the other party during a preliminary phase of generating a shared secret used to secure communication. One exemplary transaction is described below with respect to FIG. 6.

In other implementations, the cryptographic unit 310 may be implemented as an independent unit separate from the memory 304. The key storage may be provided in a separate or isolated portion of memory that is securely accessible by the cryptographic unit.

A transaction approval user interface (UI) 314 may also be stored in memory 304 and executed on CPU 302. The transaction UI 314 receives the decrypted transaction information from the cryptographic unit 310 and generates the text shown on the display 206. If the device is equipped with a more powerful display, the UI 314 may further include the ability to render graphics on the display.

The device 120 is designed to avoid exposing keys and cryptographic operations. Accordingly, certain components may be implemented using tamper-resistant technologies. As one example, the CPU 302 and memory 304 are integrated into a tamper-resistant circuit similar to that used in smart cards, as illustrated by the dashed line 316. The circuit physically protects the device from physical readout of the memory content, thereby preventing a rogue application from obtaining secure data.

FIG. 4 shows another exemplary implementation of the peripheral device, labeled as reference 400 to differentiate from device 120. Device 400 is similar to device 120 as shown in FIG. 2, but is additionally equipped with an optical component 402 that optically captures images presented on the user's computer monitor. The optical component 402 is shown positioned on the front face of the device and above the display 206, but it may be located at other places on the device. In one implementation, the optical component may be implemented as a camera that captures the image and device uses character recognition to discern what is being presented. In another implementation, the optical component 402 is a scanner that is capable of reading machine-readable demarcations.

As shown in FIG. 4, a confirmation page 404 served from the financial institution is rendered on the client monitor. The page 404 includes a machine-readable code, such as bar code 406. The optical component 402 reads the bar code 406 and bar code reader software verifies that the page is authentic to the financial institution. If the institution is valid, the device 400 translates the bar code 406 into the terms of the financial transaction and presents those terms along with the institution name on the display 206. If the user confirms the transaction (e.g., pressing OK button 208), the device generates a confirmation code based on the terms and shows the confirmation code on the display 206. The user can then enter this confirmation code in the page 404 at a designated entry location 408 and submit the confirmation back to the other party.

FIG. 5 shows selected functional components of the transaction device 400. The device is similar to device 120 of FIG. 2 in that it has a central processing unit (CPU) 302, memory 304 (e.g., volatile and non-volatile), display 206, and one or more buttons 208, 210. In addition, transaction device 400 is equipped with an optical component 402 and a reader software module 502. The reader module 502 is stored in memory 304 and executed on CPU 302, and is also protected within the tamper-resistant integrated circuit 312. If the optical component is a camera, the reader module 502 is implemented as character recognition software to recognize characters captured by a camera. Alternatively, if the optical component is a scanning element, the reader module 502 is implemented as software that understands machine readable codes scanned by an optical element.

The transaction device 400 may optionally be connected to the computer via a cable and interface (not shown in FIGS. 4 and 5). Alternatively, the transaction device 400 may be implemented as a portable, detached device that is powered independently by battery 504. In this manner, the user can capture the image or bar code by orienting the optical component 402 at the client screen (FIG. 4), and the reader module 502 interprets the characters or code to extract the terms of the financial transaction and confirmation code. If the terms are approved by the user, the confirmation code is displayed on the device display 206 and entered by the user into the appropriate entry location. One advantage of this implementation is that the device can be easily ported to more than one computer so that the user can conduct secure online financial transactions from any number of computers and kiosks.

In other implementations, the devices 120 and 400 may maintain a log of all transactions it has approved and/or rejected. This device-side log may be used to track the transactions independently of the financial party. This log may be used in a number of ways, including as providing some evidence in the event one of the parties notices a discrepancy in the transaction.

Secure Financial Transaction

FIG. 6 shows a process 600 for conducting secure online financial transactions. The process 600 is illustrated as a collection of blocks in a logical flow graph, which represents a sequence of operations that can be implemented in hardware, software, or a combination thereof. In the context of software or firmware, the blocks represent computer instructions that, when executed by one or more processors, perform the recited operations.

For discussion purposes, the process 600 is described with reference to the transaction device 120 and the architecture shown in FIG. 1. It is noted that the process 600 may be implemented by other devices and architectures. Additionally, for this example, various operations are illustrated as being performed by different computing systems, including one or more servers at the financial transaction party (e.g., servers 106(1)-106(M), 108(1)-108(S), or 110(1)-110(P)), the user's client 102, and the transaction device 120.

At blocks 602 and 604, a key setup phase is performed to establish a secret key to be shared by the financial party's server and the transaction device. In one implementation, the financial party's server passes a certificate containing its public key and other information to the transaction device 120. The device computes a key K (or selects a pre-computed key K) to be shared for the transaction. The device encrypts the key K using the server's public key and returns the encrypted version of the key K or any other information that the server might use to recompute K along with its own certificate and public key. The server then uses the returned information to decrypt and either verify K or recompute K. At this point, the shared key K is established. It is noted that, in certain implementations, the key K can be cached for the lifetime of the association with the financial party. In this manner, K is computed during the first interaction and then stored for all future interactions with that entity.

At block 606, the user's client 102 receives terms entered by the user for a financial transaction involving the financial party. The user may enter the terms via a user interface, such as via a web page 118 rendered by a browser as illustrated in FIG. 1. Continuing our above example, suppose the transaction is to purchase 100 shares of Microsoft Corporation. The user enters the trading order, and once satisfied with the terms, clicks an icon to submit the order to a financial party (e.g., a brokerage). In response to this command, the user's client 102 initiates the transaction by sending the terms to the financial party's server (block 608). The communication is made over a secure channel using security techniques, such as secure socket layer (e.g., SSL) which uses public key encryption. The communication may be represented as follows:
Client→Institution: <Buy 100 MSFT>_{SSL}

At block 610, the financial party's server processes the transaction request and generates a transaction identifier (ID). The server enciphers the terms of the transaction, including the transaction ID and a nonce generated using the key K, to create a secure message (block 612). The terms may be enciphered in a number of ways. In one approach, the financial party's server uses the key K to generate a method authentication code (MAC) from the terms, as follows:
Institution: MAC_{K}<transaction ID, Buy 100 MSFT, {nonce}_{K}>
Because the financial party chooses the nonce and the transaction ID, an attacker is unable to generate and substitute an arbitrary MAC. In another technique, the server digitally signs the transaction terms by computing a hash of the terms and signing the hash using its private key.

At block 614, the financial party's server returns a message with the transaction terms to the user for confirmation. The message includes the transaction ID, the transaction (e.g., a trade to “Buy 100 MSFT”), the nonce, and the MAC. The terms are sent back over the network to the user's client 102 via a secure channel, as follows:
Institution→Client: <transaction ID, Buy 100 MSFT, {nonce}_{K}, MAC_{K}<transaction ID, Buy 100 MSFT, {nonce}_{K}>>_{SSL}
At block 616, the client 102 receives the terms and passes them onto the transaction device 120.

At block 618, the transaction device 102 deciphers the terms. The device uses the key K to verify the nonce and MAC generated from the terms, or alternatively, verifies the digital signature as belonging to the financial party. Because only the financial party and the device can decrypt the nonce and confirm the MAC or digital signature, no other third party or rouge application running on the user's client 102 can confirm the financial transaction. The device presents the terms on the display for the user's evaluation (block 620). At block 622, the device receives either the user's approval of the transaction as presented (e.g., actuation of the “OK” button 208) or user's desire to cancel the transaction (e.g., actuation of the “No” button 210). Because there are two possible responses, verification is very efficient in this implementation.

At block 624, the device enciphers the user decision. In one implementation, the device uses the key K to generate a method authentication code (MAC) of the decision, where a response flag is set to “1” if the transaction is approved and to “0” if not approved. The encipher may be represented as follows:
Device: MAC_{K}<transaction ID, response, Buy 100 MSFT, nonce>
where the response flag is either a “1” or a “0” in this example.

The device returns the user decision to the client 102 (block 626), where it is then transmitted over the network via a secure channel (block 628), as follows:
Client→Institution: <transaction ID, MAC_{K}<transaction ID, response, Buy 100 MSFT, nonce>>_{SSL}
At block 630, the financial party's server receives the user's decision and deciphers it. Depending upon the instructions, the financial party's server either executes the transaction (if the user approved) or cancels the transaction (block 632). The financial party's server then returns a confirmation or cancellation notice (block 634) to the client 102.

FIG. 7 shows another process 700 for conducting secure online financial transactions, this time using the optical reader-enabled device 400. The process 700 is illustrated as a collection of blocks in a logical flow graph, which represent a sequence of operations that can be implemented in hardware, software, or a combination thereof. In the context of software or firmware, the blocks represent computer instructions that, when executed by one or more processors, perform the recited operations. For discussion purposes, the process 700 is described with reference to the transaction device 400 and the architecture shown in FIGS. 1 and 4.

Blocks 702-714 are essentially the same as blocks 602-614. One or more keys are established during a key setup phase (blocks 702 and 704). The user's client 102 receives a financial transaction entered by the user (block 706) and initiates the transaction by sending the proposed terms to the financial party server (block 708). The financial party's server processes the transaction request (block 710), enciphers the terms of the transaction (block 712), and returns the transaction terms to the user for confirmation (block 714).

At block 716, the client 102 receives the terms and displays them on the screen. For instance, the terms may be included in a webpage that is rendered by the client browser. The webpage may include a machine readable code, such as bar code 406 in FIG. 4. At block 718, the displayed terms are optically captured. This may be accomplished by optically reading content in the webpage and performing character recognition, or scanning the machine readable code (e.g., bar code 406). The optically read terms are deciphered (block 720) and presented on the device display for user evaluation (block 722).

At block 722, the device 400 receives either the user's approval of the transaction as presented (e.g., actuation of the “OK” button 208) or user's desire to cancel the transaction (e.g., actuation of the “No” button 210). If the user approves the transaction, the device 400 displays the confirmation code for the user to enter into the webpage to approve the transaction (block 726). At block 728, the client 102 receives the confirmation code entered by the user and sends that code to the financial party's server.

At block 730, the financial party's server receives the user's confirmation code and verifies whether its accuracy. At block 732, the financial party's server either executes the transaction (if the user approved and the code is correct) or cancels the transaction (if the user canceled or the code was inaccurate). The financial party's server then returns a confirmation or cancellation notice to the client 102 (block 734).

Other Implementations:

The two implementations of the financial device described above are intended to be non-limiting examples of possible configurations. There may be many different ways to configure the financial device, including as a single-purpose unit (similar to those above) or as part of a multi-function device.

FIG. 8 shows representative multi-purpose portable devices 800(1)-800(N), including a cell phone 800(1) and a PDA 800(N), that are designed to include technologies described above to conduct secure financial transactions with another party. These devices connect to one or more wireless communication networks 802, such as a cellular network, to communicate with the other party.

Each device 800 includes device electronics 804 to perform the one or more functions of the device, such as cellular communication, email, instant messaging, games, digital photography, digital media playback, and so forth. Each device 800 further includes transaction electronics 806 that provides a secure platform for online financial transactions. The transaction electronics 806 includes a CPU 808 and memory 810, which may be implemented as part of the device electronics 804, or separately as an independent integrated circuit with tamper-resistant design. A cryptographic unit 812 and key storage 814 are stored in memory 810 to verify financial transactions presented to the user. It is noted that, in other implementations, the transaction unit may leverage existing CPU and memory capabilities in the device electronics 804.

In this implementation, the user can initiate the transaction from one of the devices 800(1)-800(N). The financial terms are prepared by a financial party (not shown in FIG. 8), enciphered, and sent to the user's device 800 via the wireless network 802. The transaction terms are deciphered by the transactions electronics 806 and presented on the device screen. One example screen display 814 is illustrated in FIG. 8. Given the more sophisticated and powerful displays in many portable devices, the transaction terms may be presented in a more graphically rich manner to enhance user experience. After reviewing the terms on the display, the user can confirm or cancel the transaction using the device's input mechanisms, such as keypad 816 on phone 800(1) and buttons 818 on PDA 800(N). The user's decision is then enciphered by the transaction electronics 806 and returned to the other party via the network 802.

This implementation leverages existing hardware of the devices, such as a processor, memory, screen, buttons, and in some cases, a camera. Additionally, cellular networks are effective at detecting cloned devices.

FIG. 9 shows another system 900 for facilitating secure online financial transaction. System 900 includes a network transaction unit 902 connected to monitor network traffic between the user's computer 904 and the network 906. The network transaction unit 902 has a pair of network ports to connect to the computer's network port and to the network 906.

The network transaction unit 902 is configured to intercept all traffic from predetermined sensitive sites of potential parties in a financial transaction. The unit is configured with the ability to access the secure SSL pipe between the user computer 904 and network 906, decrypt the packets being transferred through the pipe, and gain access to the enciphered financial terms. Thus, when a financial transaction is in progress, the transaction unit 902 receives the enciphered terms from the financial party and deciphers them. The transaction unit 902 is therefore privy to the financial terms and what the webpage presenting those terms is “supposed” to look like.

The transaction unit 902 is also able to discover the content as actually presented to the user. This may be done in a number of ways. In one approach, which is shown in FIG. 9, a camera or bar code scanner 908 optically reviews the webpage 910 presented on the computer monitor. The camera may capture some or all of the webpage 908 and provide that image to the unit 902, which then employs graphical techniques (e.g., Optical Character Recognition) or bar code reading techniques to understand the terms being displayed. The unit 902 compares the optically-recovered terms presented on the monitor with those intercepted on the network directly from the financial party to discover any disparities between them. In another approach, no additional camera is provided and the transaction unit 902 reads monitor traffic between the computer CPU (or graphics card) and the computer monitor. The unit 902 compares the data being sent to the monitor with the terms intercepted from the network to determine if there are any differences.

If the two sets of terms are identical, the transaction unit 902 informs the user that the terms are the same as negotiated. This may be done by illuminating a dedicated light on the unit (e.g., LED), color coding an illuminated light (e.g., green-colored LED for okay), or displaying a message on the unit's display 912. The user may then approve or cancel the transaction by pressing a button on the unit 902, or entering a confirmation code provided on the unit's display 912 into the webpage at entry 914.

If the two sets of terms are not identical, the transaction unit 902 informs the user that there is an error in the terms. This may be done by illuminating a different light on the unit, or changing the color of the light (e.g., turn the LED to red to signify error), or displaying a warning message on the unit's display 912. The user may then cancel the transaction by pressing a button on the unit 902, or choosing a cancel option in webpage 910.

Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claimed invention.

What is claimed is:

1. A peripheral device separate from and peripheral to a computing device, comprising:
an interface to couple to the computing device to receive enciphered terms of a financial transaction transmitted from a financial party over a network to the computing device;
a memory to store the enciphered terms of the financial transaction;
a processor coupled to the memory to decipher the terms of the financial transaction;
a display to present the terms deciphered by the processor; and
at least one user input mechanism to enable a user to one of confirm or cancel the financial transaction according to the terms presented on the display.

2. A peripheral device as recited in claim 1, wherein the interface comprises a USB connector.

3. A peripheral device as recited in claim 1, wherein the interface comprises a wireless connector.

4. A peripheral device as recited in claim 1, wherein the processor uses public key cryptography to decipher the terms.

5. A peripheral device as recited in claim 1, wherein the memory stores a pair of public and private keys, and the processor deciphers the terms using at least one of the public key, the private key, or a third key generated from the public and private keys.

6. A peripheral device as recited in claim 1, wherein the memory and the processor are formed on as an integrated circuit with a tamper-resistant design.

7. A peripheral device as recited in claim 1, wherein the device enciphers a reply to confirm or cancel the financial transaction and transfers the reply back to the financial party via the interface.

8. A peripheral device as recited in claim 1, wherein a machine readable code representative of the financial transaction is depicted on the computing device, and the interface comprises an optical unit to optically read the machine readable code.

9. A peripheral device as recited in claim 8, wherein, upon user confirmation, the device presents a confirmation code on the display for user entry into the computing device.

10. A peripheral device as recited in claim 1, wherein the device employs secure characters when presenting the terms on the display, wherein the secure characters are not part of the terms.

11. A peripheral device separate from and peripheral to a computing device, comprising:
means for receiving terms in a financial transaction transmitted from a financial party over a network to the computing device, the terms being enciphered using a key known to the peripheral device and the financial party, but unknown to the computing device;
means for deciphering the terms using the key;
means for indicating whether the terms received from the financial party are identical to the terms being presented to the user by the computing device;
means for enabling the user to submit a decision whether to approve or cancel the financial transaction; and
means for enciphering the decision using the key for transmission from the computing device back over the network to the financial party.

12. A peripheral device as recited in claim 11, wherein the receiving means comprises a USB connector coupled to the computing device.

13. A peripheral device as recited in claim 11, wherein the receiving means comprises a wireless receiver to receive the terms over a wireless network.

14. A peripheral device as recited in claim 11, wherein the receiving means comprises an optical component to optically read the terms.

15. A peripheral device as recited in claim 1 1, wherein the deciphering means and the enciphering means comprises a cryptographic engine executing on a processing unit to perform public key decryption and encryption.

16. A peripheral device as recited in claim 11, wherein the indicating means comprises a display.

17. A peripheral device as recited in claim 11, wherein the indicating means comprises one or more lights.

18. A peripheral device as recited in claim 11, wherein the enabling means comprises one or more user input mechanisms.

19. A peripheral device as recited in claim 11, wherein the enabling means comprises a display to depict a confirmation code.

20. A system for conducting an online financial transaction, comprising:
a computer to connect to a network and engage in an online financial transaction with a financial party, the financial transaction having a set of terms that are enciphered by the financial party using a secret that is unknown to the computer's main memory and computational resources; and
a transaction device separate from and peripheral to the computer, the transaction device deciphering the terms of the financial transaction using the secret and permitting a user to confirm or cancel the financial transaction based on the deciphered terms.

21. A system as recited in claim 20, wherein the transaction device is connected to the computer via a serial connection.

22. A system as recited in claim 20, wherein the computer displays the terms on a monitor and the transaction device comprises an optical device to optically capture the terms and compare the terms with the deciphered terms.

23. A system as recited in claim 20, wherein the transaction device is coupled between the computer and a network used to communicate with the financial party.

24. A system as recited in claim 20, wherein the transaction device comprises a display to show the deciphered terms received from the financial party.

25. A system as recited in claim 20, wherein the transaction device comprises:
a display to show the deciphered terms received from the financial party; and
a user input mechanism to enable a user to accept or cancel the financial transaction based on the deciphered terms shown on the display.

26. A system as recited in claim 20, wherein the transaction device comprises a display to show a confirmation code in an event the deciphered terms are accurate.

27. A computer readable media storing computer-executable instructions that, when executed by a processor, perform acts comprising:
receiving terms of a financial transaction that are transmitted over a network to a computing device associated with a user who is party to the financial transaction, the terms being enciphered by a second party to the transaction;
deciphering and storing the terms in a manner that is protected from access by the computing device;
presenting the terms to the user;
enabling the user to one of approve or cancel the transaction based on the presented terms;
enciphering a reply containing the user's approval or cancellation of the transaction; and
returning the enciphered reply back over the network via the computing device to the second party to the transaction.

28. A computer readable media as recited in claim 27, wherein the computing device comprises a personal computer, and the terms are received over the Internet.

29. A computer readable media as recited in claim 27, wherein the computing device comprises a cellular phone, and the terms are received over a wireless phone network.

30. A computer readable media as recited in claim 27, further storing computer-executable instructions that, when executed by a processor, perform additional acts comprising:
optically reading terms in clear form displayed by the computing device; and
comparing the terms read optically with the deciphered and stored terms.

31. A device comprising:
a display;
the computer readable media as recited in claim 27; and
a processor to execute the instructions stored on the computer readable media such that the terms are presented on the display.

32. A device comprising:
a display;
an optical unit;
the computer readable media as recited in claim 27; and
a processor to execute the instructions stored on the computer readable media;
wherein the terms are shown in a machine readable format on the computing device and the optical unit reads the terms and presents the terms on the display.

33. A cellular phone comprising the computer readable media as recited in claim 27.

34. A personal digital assistant comprising the computer readable media as recited in claim 27.

35. A method for conducting an online financial transaction between a user and a financial party over a network, the method comprising:
enciphering terms in the financial transaction at the financial party;
transmitting the enciphered terms over a network to a computing device;
passing the enciphered terms from the computing device to a transaction device separate from the computing device;
deciphering the terms at the transaction device;
presenting the deciphered terms on the transaction device to a user;
receiving input from the user regarding a decision to one of approve or cancel the financial transaction based upon the terms presented on the transaction device;
enciphering the user decision at the transaction device;
passing the enciphered user decision from the transaction device to the computing device; and
transmitting the enciphered user decision over the network where the financial party can decipher the user decision to determine whether to complete or cancel the financial transaction.

36. A method as recited in claim 35, wherein the enciphering and deciphering comprises encrypting and decrypting the terms using public key cryptography.

37. A method as recited in claim 35, further comprising:
displaying the terms of the financial transaction on the computing device;
optically reading the terms; and
comparing the terms optically read from the computing device with the deciphered terms.

38. A method for conducting an online financial transaction where terms of a financial transaction are transmitted over a network from a first party to a computing device associated with a second party, the method comprising:
receiving the terms of the financial transaction from the computing device, the terms being in an enciphered form unreadable by the computing device;
deciphering the terms;
presenting the terms to second party;
enabling the second party to approve or cancel the transaction based on the presented terms; and
returning the second party's decision to approve or cancel the financial transaction to the first party via the computing device and the network.

39. A method as recited in claim 38, wherein the receiving comprises receiving the terms over a USB connection to the computing device.

40. A method as recited in claim 38, wherein the receiving comprises optically reading a clear form of the terms displayed by the computing device.

41. A method as recited in claim 38, wherein the presenting comprises displaying the terms on a display screen of a device that is separate from the computing device.

42. A method as recited in claim 38, further comprising enciphering the second party's decision prior to said returning.

43. A method for accommodating financial transaction over a network, comprising:
distributing transaction devices to a plurality of customers, each transaction device having a unique key;
negotiating terms of the financial transaction using a customer's computing device; and
facilitating user confirmation of the terms of the financial transaction through secure communication with the transaction device via the user's computing device.
